(19) United States
(12) Patent Application Publication
(10) Pub. No.: US 2005/0240831 A1
(43) Pub. Date: Oct. 27, 2005

(54) Universal controller and graphical user interface

(76) Inventors: William D. Balkman, Austin, TX (US); Ziyad H. Doany, Austin, TX (US); Jerry D. Jackson, Dripping Springs, TX (US); Corey M. Willson, Dripping Springs, TX (US)

Correspondence Address: 3M INNOVATIVE PROPERTIES COMPANY, PO BOX 33427, ST. PAUL, MN, 55133-3427, US

(21) Appl. No.: 10/815,006

(22) Filed: Mar. 31, 2004

(51) Int. Cl. G06F 11/00

(52) U.S. Cl. 714/46

(57) ABSTRACT

A graphical user interface (GUI) processor to control one of multiple different test devices. A user provides instructions via an input interface. The GUI processor includes a translator to receive the instructions input by the user and may also receive a signal indicating the type of test processor. The instructions input by the user are translated into test device commands based on the type of test device. The test device commands are transmitted to the test device, and test results are received from the test device and converted into display controls. A display engine is coupled to receive the display controls and drives a display to display the test results. In one exemplary embodiment, the display is adjustable based on the type of test device to only provide the user with options that correspond to the capabilities available on the test device.

### BACKGROUND OF THE INVENTION

The present invention relates to a controller for multiple test instruments, and more particularly to a graphical user interface (GUI) for a controller that is configured to operate with a number of different test instruments.

In the telecommunications industry, as well as in other industries, there are many different kinds of test instruments for performing various diagnostics. Most of the more recently developed test instruments employ a GUI with an input device such as a keyboard or touch screen. The output of the GUI in such instruments is presented to the user on an output mechanism such as a liquid crystal display (LCD). The GUI typically displays functions of the test instrument in a symbolic or graphical formal that the user can select via the input device. Each function is typically represented by at least a symbol and possibly text as well, rather than by text alone. This type of interface has been shown to make understanding and learning about the operation of the test instrument easier.

When a function is selected in the GUI by the user, it generally causes a test or measurement to be performed by the test portion (i.e., test processor) of the instrument. The results of the test or measurement are then provided to the GUI portion (i.e., GUI processor) for presentation to the user on the display. To achieve this function, the GUI processor executes software that converts the user's selection into a specific test request or command that is executed by the test processor. This function is performed whether the test processor and GUI processor are integrated into the same instrument, or whether the test instrument is controlled by an external instrument such as a handheld computer or the like which communicates with the test instrument through a communications link such as a wired or wireless link, for example. In either case, the software associated with the GUI processor is pre-programmed to work with the specific test instrument that is to be controlled.

The ability to perform multiple different test functions has been provided in existing devices by integrating all of the test functions into a single device and pre-programming a processor to control those test functions. An example of this type of device is the Dynatel™ 965DSP Subscriber Loop Analyzer manufactured by 3M Corporation of St. Paul, Minn. Other devices that include hard-coded processors controlling test functions may be found in the telecommunications and automotive diagnostics industries, for example.

### BRIEF SUMMARY OF THE INVENTION

While the existing approach to control of test instruments has been effective to control a single instrument with a single test processor, it would be useful to provide a common GUI that controls multiple test instruments. This would allow users, repair technicians and engineers to become familiar and skilled with a single GUI and associated processing hardware and software, and would provide a great deal of flexibility to a user who uses multiple test instruments by operating the instruments with a single controller. In addition, the cost of integrating an entire suite or multiple suites of test functions into a single device can be alleviated by using test devices that provide smaller sets of test functions controlled by a common controller and a common GUI.

A graphical user interface (GUI) processor controls one of multiple different test devices. A user provides instructions via an input interface. The GUI processor includes a translator that is coupled to the input interface to receive the instructions input by the user. The translator may also receive a signal indicative of the type of test processor connected to the GUI processor. The instructions input by the user are translated into test device commands based on the type of test device that is connected to the GUI processor. The test device commands are transmitted to the test device, and test results are received from the test device and converted into display controls. A display engine is coupled to receive the display controls and to cause a display to display the test results. In one embodiment, the display is adjustable based on the type of test device to only provide the user with options that correspond to the capabilities available on the test device.

### BRIEF DESCRIPTION OF THE DRAWINGS

FIG. 1 is a diagram of an existing test instrument having an integrated graphical user interface (GUI).

FIG. 2 is a diagram of an existing test instrument having a separate control module and GUI.

FIG. 3 is a diagram of an exemplary GUI processor that is operable to interact with a plurality of different test devices/processors.

FIG. 4A is a flow diagram illustrating an exemplary method of translating GUI commands into test processor commands.

FIG. 4B is a flow diagram illustrating an exemplary method of converting test processor measurement results into GUI display commands.

FIG. 5 is a diagram illustrating an exemplary hand-held computer that includes a GUI processor for controlling telecommunications test devices.

FIG. 6 is a diagram of an exemplary telecommunications test device that includes a test processor and circuitry for performing one or more test functions on a communications cable.

FIG. 7A is a diagram illustrating an exemplary GUI display for a test device having a first set of test capabilities.

FIG. 7B is a diagram illustrating an exemplary GUI display for a test device having a second set of test capabilities.

FIGS. 8A-8H are diagrams illustrating exemplary GUI display screens for the test functions that can be performed by a communications test device.

### DETAILED DESCRIPTION

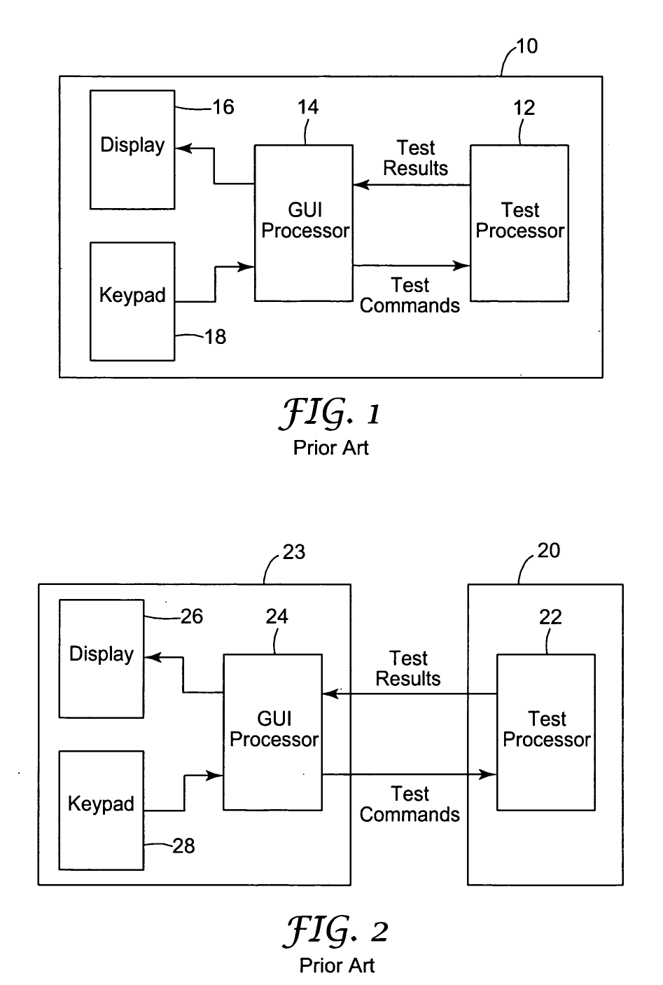

FIG. 1 is a diagram of test instrument 10 having an integrated graphical user interface (GUI). Test instrument 10 includes test processor 12, GUI processor 14, display 16 and an input device such as keypad 18. Test processor 12 performs a test of some kind, and communicates with GUI processor 14 by receiving test commands from GUI processor 14 and transmitting test results to GUI processor 14. GUI processor 14 interprets the test results and formats them appropriately for viewing on display 16. Keypad 18 serves as an input device that allows a user to input instructions that are formatted by GUI processor 14 into the test commands that are sent to test processor 12.

FIG. 2 is a diagram of existing test instrument 20 having a separate control module and GUI. Test instrument 20 includes test processor 22, and separate control module 23 includes GUI processor 24, display 26 and an input device such as keypad 28. Test processor 22 performs a test of some kind, and communicates with GUI processor 24 (via a wired or wireless link) by receiving test commands from GUI processor 24 and transmitting test results to GUI processor 24. GUI processor 24 interprets the test results and formats them appropriately for viewing on display 26. Keypad 28 serves as an input device that allows a user to input instructions that are formatted by GUI processor 24 into the test commands that are sent to test processor 22.

In both of the instrument configurations shown in FIGS. 1 and 2, the GUI processors are specifically programmed and configured to communicate with the individual test processors of the test instruments. If a different test processor were to be connected to the GUI processor, additional programming and configuration would be required for the system to operate properly. In other words, if the test processor of the types shown and described in FIGS. 1 and 2 were modified to delete or include other test functions, or if a new test processor were substituted, the GUI processor would also have to be modified to accommodate the changes.

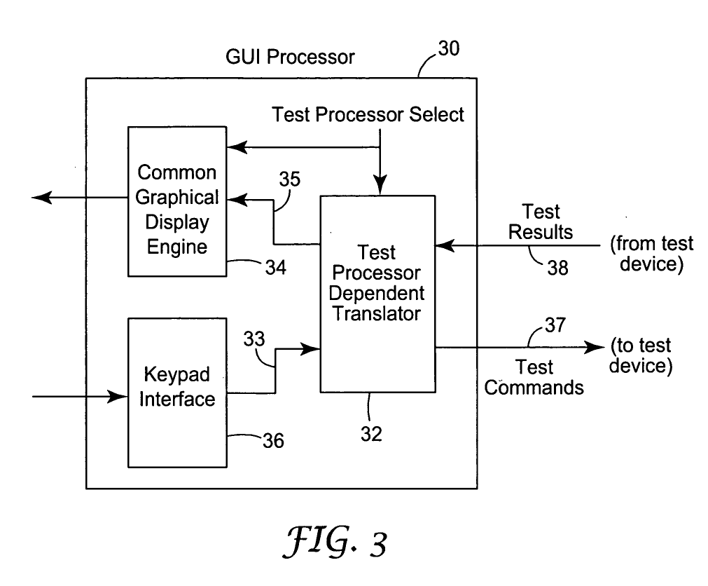

FIG. 3 is a diagram of exemplary GUI processor 30 that interacts with a plurality of different test devices and their associated processors. GUI processor 30 includes test processor dependent translator 32, common graphical display engine 34, and an input device interface such as keypad interface 36 for receiving input signals. Test processor dependent translator 32 receives a test processor select signal that indicates the type of test processor that is connected to GUI processor 30. The test processor select signal may be generated by signal communication and logic capability in GUI processor 30 that receives a signal from the connected test processor and determines the processor type, or may be provided in another manner such as in response to manual input by a user, for example. Common graphical display engine 34 also receives the test processor select signal to provide the capability to adjust the appearance of the display based on the type of test processor that is connected to GUI processor 30. For example, common graphical display engine 34 may receive information from the test processor select signal that indicates what types of measurements are able to be made by the device and its associated test processor, and may adjust the appearance of the display to show only the available types of measurements as options for the user to select.

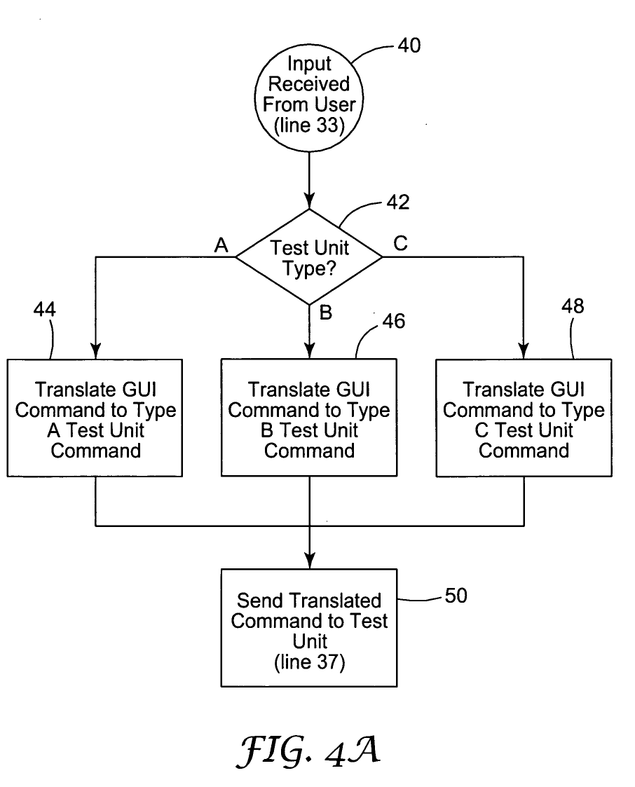

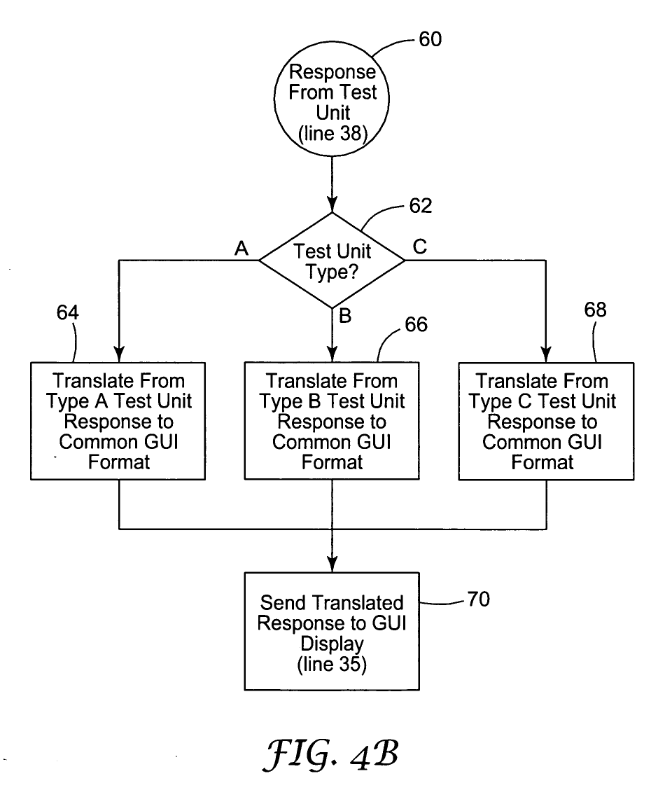

Test processor dependent translator 32 translates data received from a test processor and encodes commands for execution by the test processor, and also converts test results received from a test device into display commands, according to the flow diagrams shown in FIGS. 4A and 4B. Although test dependent processor 32 has been shown as a single functional block in FIG. 3, it will be understood by those skilled in the art that the translation of user inputs and the conversion of test results from a test device can in some embodiments be performed by different structural components. As shown in FIG. 4A, a command input is initially received at block 40 from the user, indicating that a measurement is to be made by the test unit being utilized. If the device is adapted as described above to determine and display the types of tests that can be run by the test unit, then the input from the user at block 40 could be the user's selection of a test from the displayed tests available. The type of test unit is determined at block 42. As discussed above, this determination may be automatically made by signal communication and logic circuitry of the GUI processor that queries the test unit for information about its make and model, or may be made manually such as by an input from the user in response to a query, for example. Once the test unit type is determined, the command input by the user (also referred to as a GUI command) is translated by the test dependent processor into a test unit command, according to the type of test unit employed. In the embodiment illustrated by FIG. 4A, three types of test units (A, B and C) are available. It will be understood by those skilled in the art that any number of test unit types may be accommodated. The GUI command is converted to a type A test unit command at block 44 if the test unit is determined to be a type A unit, is converted to a type B unit command at block 46 if the test unit is determined to be a type B unit, and is converted to a type C unit command at block 48 is the test unit is determined to be a type C unit. The translated command is then sent to the test unit at block 50, and the test unit makes the measurement commanded.

The translation of GUI commands into test unit commands may be accomplished in a number of ways. In one exemplary embodiment, lookup tables are employed that are addressable by an index (the GUI command). Unique lookup tables are maintained for each type of test unit available. For the example of FIG. 4A, three lookup tables are maintained, for test unit types A, B and C, respectively. Each lookup table contains all of the possible commands that may be executed by the particular test unit type. Exemplary entries in a lookup table for a device operable to measure parameters related to the tip (T), ring (R) and ground (G) conductors of a communications cable are shown below in Table 1.

TABLE 1

| Index (GUI Command) | Test Unit Command Output |
|---|---|
| VOLTS-TR | V-TR |
| VOLTS-TG | V-TG |
| . . . | . . . |
| OHMS-RG | O-RG |

The entries shown in Table 1 are in a format that is customized for the GUI software that is being used and for the particular test device that is connected. Other test devices may require commands in a different format, such as a binary format, for example. GUI processor 30 translates the GUI commands into the format that is appropriate for the test device being used.

In another exemplary embodiment, a logic-based solution may be employed, such as decision tree logic that compares the GUI command entered by the user to all of the possible choices and selects the appropriate test unit command based on the results of the comparison. An example of a programming statement that could be utilized to execute this logic is the Switch-Case statement in the C programming language. Other variations of the logic-based solution will be apparent to those skilled in the art. For example, if the input provided by the user does not exactly match the name or description of a test that the test device is capable of running, then the device can either translate the GUI command into commands that will operate the test unit most closely related to the test requested, or prompt the user to select from among one or more tests the one that is desires, or take other action(s), depending on how the device is configured.

FIG. 4B illustrates the process of transmitting measurement results from the test unit to the GUI processor. A measurement response from the test unit is initially provided as indicated at block 60. In some embodiments, the test unit continuously streams measurement results until an idle command or another measurement command is received. In other embodiments, the test unit performs the commanded measurement once, returns the result and becomes idle. It is also possible for different measurements performed by a single device to be continuous and others to be performed once, as appropriate for the particular measurement being performed. The type of test unit is determined at block 62, similar to the manner described above, or may already be known to the device based on preceding steps. The response from the test unit is then translated into a format suitable for controlling the graphical display (also referred to as common GUI format). In the embodiment illustrated by FIG. 4B, test unit types A, B and C are again available. The test unit response for a type A test unit is converted to a common GUI format at block 64, the test unit response for a type B unit is converted to a common GUI format al block 66, and the test unit response for a type C test unit is converted to a common GUI format at block 68. The converted test unit response is then sent to the GUI control circuitry (such as common graphical display engine 34, FIG. 3) at block 70, to display the results of the measurements taken by the test unit.

The conversion of test unit measurement responses into display commands may be accomplished in a number of ways, similar to the discussion of the translation of GUI commands into test unit commands above. In one embodiment, lookup tables are employed that are addressable by an index (i.e., the test unit measurement response). Unique lookup tables are maintained for each type of test unit available. For the example of FIG. 4B, three lookup tables are maintained, for test unit types A, B and C, respectively. Each lookup table contains all of the possible measurement responses that may be returned for the particular test unit type. Exemplary entries in a lookup table for a device operable to measure parameters related to the tip (T), ring (R) and ground (G) conductors of a communications cable are shown below in Table 2.

TABLE 2

| Index (Measurement) | Output to GUI |
|---|---|
| V-TR-XX.X | XX.X V |
| V-TG-XX.X | XX.X V |
| . . . | . . . |
| O-RG-XX.XK | XX.X KOhms |

The entries shown in Table 2 are in a format that is customized for the GUI software that is being used and for the particular test device that is connected. Other test devices may produce measurement results in a different format, such as a binary format. GUI processor 30 translates the test device measurement results into the appropriate GUI software format, regardless of the measurement result format.

### EXAMPLE

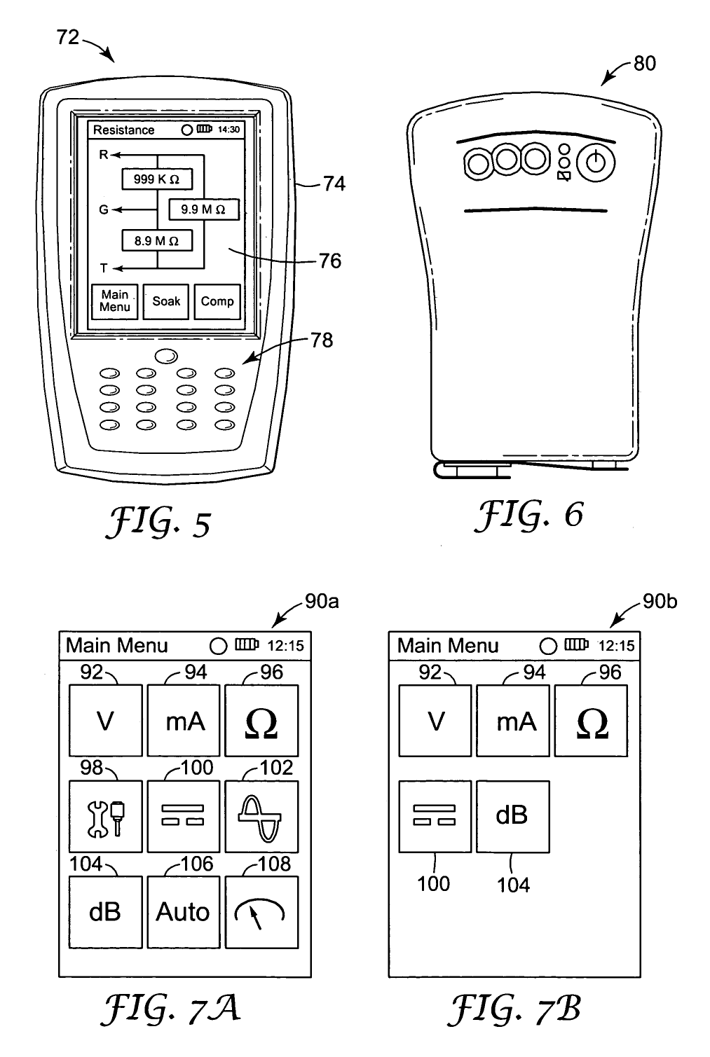

An example of a common GUI controller (a hand-held computer) for controlling multiple different communications test devices, test processors, and GUI are shown and described in FIGS. 5, 6, 7A, 7B and 8A-8H.

FIG. 5 is a diagram of exemplary hand-held computer 72 that includes a GUI processor such as GUI processor 30 described above with respect to FIG. 3. Hand-held computer 72 includes housing 74, display 76 having a touch sensitive screen, and keypad 78. A user may input instructions via the touch sensitive screen or via keypad 78. Display 76 shows an exemplary results screen for a resistance measurement function.

Hand-held computer 72, via its GUI processor (described above with respect to FIG. 3), is equipped with the capability to communicate with multiple different test devices. Hand-held computer 72 is also equipped with the capability to communicate with a PC, such as a truck-mounted PC, to receive dispatch or other information via Bluetooth wireless communication, wired communication via an RS-232 serial link, or by other wired or wireless means. Alternatively, hand-held computer 72 could be equipped with a wireless LAN or WAN card to provide the capability to communicate with a server or other networked devices directly without using a PC.

FIG. 6 is a diagram of exemplary communications test device 80 that includes a test processor and circuitry for performing one or more test functions on a communications cable. Test device 80 also includes an internal Bluetooth wireless interface and a serial interface for communication with hand-held computer 72 of FIG. 5. Other wired or wireless interfaces could also be provided. In most embodiments, test device 80 will not include its own display, since the display is provided by the GUI of the computer that is connected to control test device 80. This reduces the manufacturing cost of test device 80.

FIG. 7A is a diagram illustrating exemplary GUI display 90a on hand-held computer 72 for controlling telecommunication test device 80 having at least nine different test capabilities (a full suite of “I&R” (installation and repair) communications tests). GUI display 90 a provides a user with the options of selecting a voltage measurement (box 92), a current measurement (box 94), a resistance measurement (box 96), a “tool box” function (box 98) for selecting options such as language setup, ohms-to-distance calculation, a load coil counter function, a ringer count function, etc., a function measuring the distance to an open on the cable pair (box 100), a tone function (box 102) for generating a sinusoidal tone on the connected conductors, a dB measurement function (box 104) for measuring signal loss, noise, power influence and pair balance, an Auto test function (box 106) for making a series of successive measurements on the connected conductors, or a kick test function (box 108). These measurement and function options are shown on GUI display 90a because the common graphical display engine detects that the test processor being used has all of these capabilities.

FIG. 7B is a diagram illustrating exemplary GUI display 90b for an alternative test device having only five different test capabilities. GUI display 90b provides a user only with the options of selecting a voltage measurement (box 92), a current measurement (box 94), a resistance measurement (box 96), a function measuring the distance to an open on the cable pair (box 100) or a dB measurement function (box 104) for measuring signal loss, noise, power influence and pair balance. The common graphical display engine does not display the options that are not available to the user, reducing the complexity and clutter of the GUI for operation by the user. Test options from which the user may select can be displayed in graphical form, alphanumeric form, or a combination of both (including one in which an alphanumeric description appears on the GUI when a cursor is placed over a graphic, for example).

A user has the ability to select a desired test from the options listed on GUI display 90a (FIG. 7A) or 90b (FIG. 7B). As described above with respect to FIG. 4A, the user selects a test function (block 40), the test device type is determined (block 42), and the test function that is commanded is translated into an appropriate command for the type of test device that is being used (blocks 44, 46, 48). The translated command is then transmitted to the test device to perform the selected test (block 50)

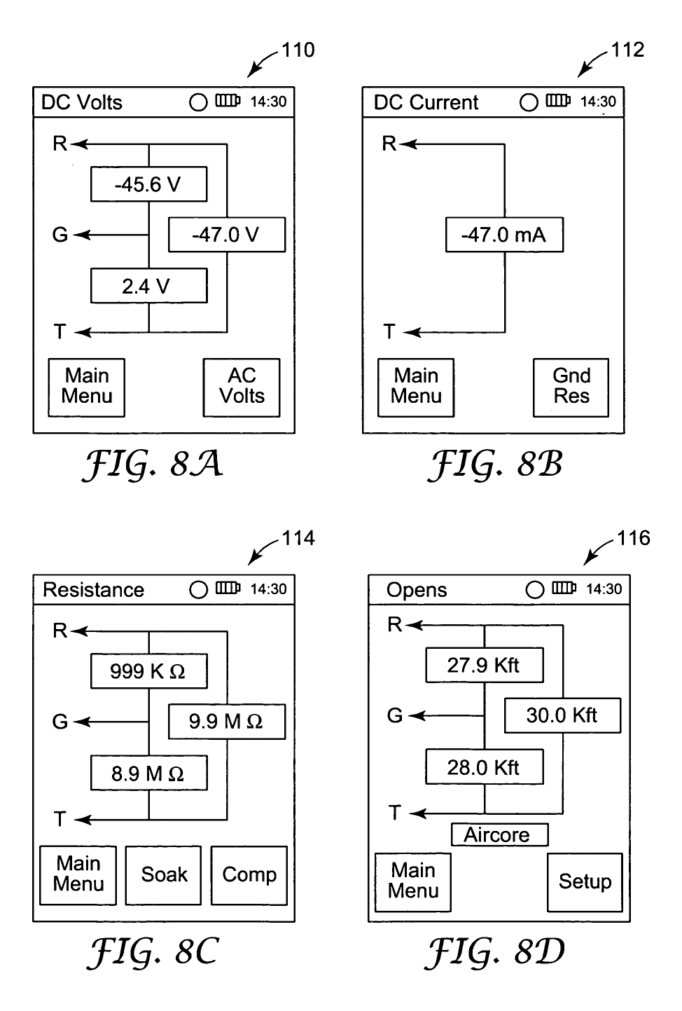

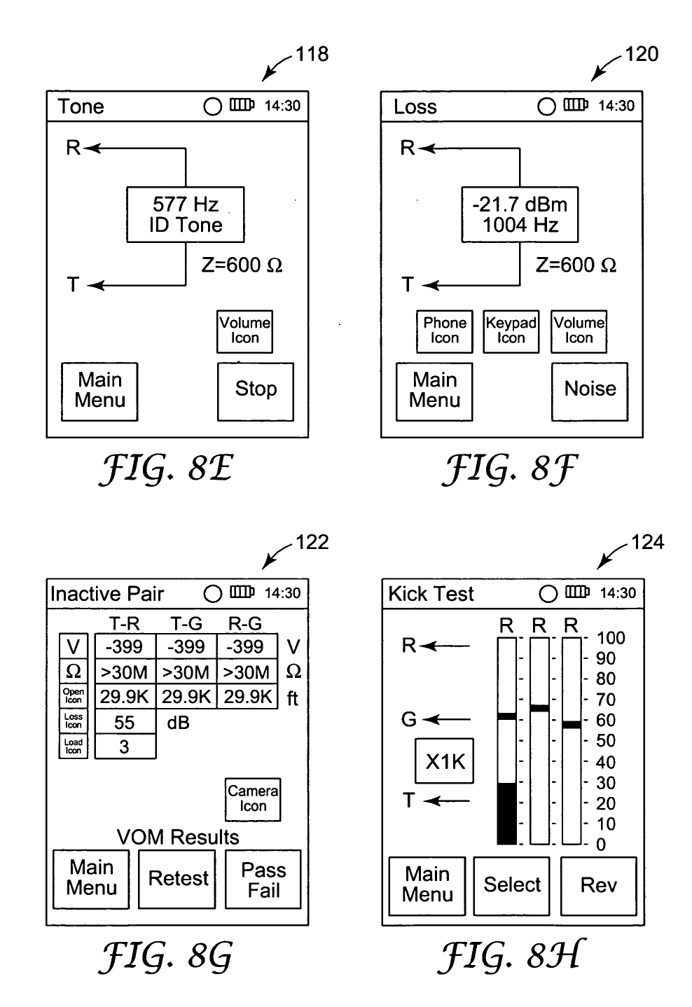

FIGS. 8A-8H are diagrams illustrating exemplary GUI display screens for a selection of test functions that can be performed by communications test device 80 (FIG. 6). FIG. 8A illustrates GUI display screen 110 for measuring voltage between the tip (T), ring (R) and ground (G) conductors of a communications cable. This test function can be initiated by selecting box 92 of the menu shown in FIG. 7A. FIG. 8B illustrates GUI display screen 112 for measuring loop current from a central office to a customer's premises. This test function can be initiated by selecting box 94 of the menu shown in FIG. 7A. FIG. 8C illustrates GUI display screen 114 for measuring the insulation resistance between conductors of the communications cable. This test function can be initiated by selecting box 96 of the menu shown in FIG. 7A. FIG. 8D illustrates GUI display screen 116 for measuring the capacitive length of a communications cable (also known as an “opens” measurement). This test function can be initiated by selecting box 100 of the menu shown in FIG. 7A. FIG. 8E illustrates GUI display screen 118 for initiation of a sinusoidal voice-band tone used to measure loss over a communications cable. This test function can be initiated by selecting box 102 of the menu shown in FIG. 7A. FIG. 8F illustrates GUI display screen 120 for measuring the loss level of a tone (also known as a “dB” measurement). This test function can be initiated by selecting box 104 of the menu shown in FIG. 7A. FIG. 8G illustrates GUI display screen 122 for displaying the results of a sequence of predetermined tests to determine the overall health of a communications cable (also known as an “Auto test” measurement sequence). In the example shown in FIG. 8G, this test sequence includes voltage measurements, resistance measurements, “opens” measurements, a “loss” measurement and a “load coils” measurement, which are known in the art. The “Auto test” measurement function can be initiated by selecting box 106 of the menu shown in FIG. 7A. FIG. 8H illustrates GUI display screen 124 for displaying the results of a “kick test,” which is known in the art. This test function can be initiated by selecting box 108 of the menu shown in FIG. 7A.

The display screens shown in FIGS. 8A-8H are provided by converting measurement results from a test device into display commands, as described above with respect to FIG. 4B. The measurements are transmitted from the test device to the GUI processor (block 60), the test device type is determined (block 62), and the measurements are translated into an appropriate GUI format (blocks 64, 66, 68). The translated display commands are then provided to the GUI display (block 70).

The test functions described above provide a suite of communications tests for a user, such as a cable installation and repair technician. Generally, a full suite of communications tests includes tests categorized as installation and repair, construction and maintenance, cable maintenance, and special services. Other suites of test functions may be useful to provide in a test device, either as a limited set of functions within the full suite of tests (such as is shown in the reduced set of menu options of FIG. 7B) or as an entirely different suite of test functions. One example of other test functions are those provided by an optical testing module, which may provide the ability to perform an optical loss test, a light level/intensity test, and other functions. Further testing options that may be provided by a test device connected to a common GUI will be apparent to those skilled in the art.

The common GUI provided by the present invention allows multiple types of test units to be controlled by a single device having a GUI with an appearance that can be made somewhat universal for all of the different devices. The GUI can also be adapted, within its general appearance, to only display options to the user that are available for performance by the particular test unit that is being used. These capabilities allow users to become familiar with a single GUI for controlling a number of different devices, which will improve the users' efficiency of operation, while reducing the complexity and potential for confusion to the user by only displaying options that are available for the particular type of test unit being used. In some embodiments, these capabilities are invisible to the user, provided by automatic interrogation performed by the common GUI controller to determine the capabilities of the test unit that is connected.

The ability to control multiple different test devices is particularly appealing in the communications industry, where communications cables are being used to support a variety of different communication services, such as traditional voice service, digital voice and data services, video services, and others. Various suites of test functions can be provided by relatively low cost test devices, all of which can be controlled by a common hand-held computer with a common GUI.

Although the present invention has been described with reference to preferred embodiments, workers skilled in the art will recognize that changes may be made in form and detail without departing from the spirit and scope of the invention. The invention can also be used in fields outside the communications field.

1. A graphical user interface (GUI) processor for selective connection to one of at least two different test devices, the GUI processor comprising:
an input interface for receiving instructions from a user;
a translator adapted to:
receive the instructions input by the user;
translate the instructions input by the user into test device commands based on a type of test device connected to the GUI processor;
transmit the test commands to the test device and receives test results from the test device; and
convert the test results received from the test device into display controls; and
a display engine that receives the display controls from the translator and causes a display to display the test results.

2. The GUI processor of claim 1 in combination with a test device that receives test commands and provides test results, the test device being communicatively coupled to the GUI processor by a wired or wireless communication link.

3. The GUI processor of claim 2, wherein the test device is adapted to perform a suite of tests on a cable.

4. The GUI processor of claim 3, wherein the suite of tests that can be performed by the test device is a fall suite of telecommunications tests.

5. The GUI processor of claim 3, wherein the suite of tests that can be performed by the test device is a subset of a full suite of telecommunications tests.

6. The GUI processor of claim 1, wherein the translator receives a signal indicative of the type of test device connected to the GUI processor.

7. The GUI processor of claim 6, wherein the display engine receives the signal indicative of the type of test device connected to the GUI processor and causes the display to present options to the user that correspond only to capabilities that are available on the test device that is connected to the GUI processor.

8. The GUI processor of claim 1, further including signal communication and logic circuitry for communicating with the test device connected to the GUI processor and determining the test device type.

9. The GUI processor of claim 1, wherein the translator employs a first lookup table to translate the instructions input by the user into test device commands, the first lookup table being selected from a first plurality of lookup tables based on the type of test device connected to the GUI processor.

10. The GUI processor of claim 9, wherein the translator employs a second lookup table to convert the test results received from the test device into display controls, the second lookup table being selected from a second plurality of lookup tables based on the type of test device connected to the GUI processor.

11. The GUI processor of claim 1, wherein the translator employs a lookup table to convert the test results received from the test device into display controls, the lookup table being selected from a plurality of lookup tables based on the type of test device connected to the GUI processor.

12. The GUI processor of claim 1, wherein the translator executes software to translate the instructions input by the user into test device commands based on the type of test device connected to the GUI processor.

13. The GUI processor of claim 1, wherein the translator executes logic software to convert the test results received from the test device into display controls based on the type of test device connected to the GUI processor.

14. The GUI processor of claim 1, wherein the translator translates instructions into test device commands for telecommunications test devices configured to perform tests on telecommunications cables.

15. A method of controlling a test device selected from a plurality of test devices, the method comprising:
receiving instructions from a user;
translating the instructions input by the user into test device commands based on a type of test device being controlled;
transmitting the test device commands to the test device;
receiving test results from the test device; and
displaying the test results.

16. The method of claim 15, further comprising:
receiving a signal indicative of the type of test device being controlled.

17. The method of claim 16, further comprising:
interrogating the test device being controlled to generate the signal indicative of the type of test device being controlled.

18. The method of claim 15, wherein displaying the test results comprises:
converting the test results into display controls; and
driving a display with the display controls to display the test results.

19. The method of claim 15, further comprising:
adjusting the display based on the type of test device being controlled to provide only options to the user that correspond to capabilities available on the type of test device being controlled.

20. The method of claim 15, wherein translating the instructions input by the user into test device commands is performed by employing a lookup table selected from a plurality of lookup tables based on the type of test device being controlled.

21. The method of claim 15, wherein converting the test results into display controls is performed by employing a lookup table selected from a plurality of lookup tables based on the type of test device being controlled.

22. The method of claim 15, wherein translating the instructions input by the user into test device commands is performed by executing logic software based on the type of test device being controlled.

23. The method of claim 15 wherein converting the test results into display controls is performed by executing logic software based on the type of test device being controlled.

24. A telecommunications testing system for performing at least one test on a telecommunications cable, comprising:
a test device for performing a suite of tests on the telecommunications cable and generating test results; and
a controller coupled to the test device, the controller:
determining the type of test device coupled to the controller;
providing a graphical user interface (GUI) and a display that represents only test capabilities available for the type of test device that is determined to be coupled to the controller;
initiating performance of one of the suite of tests by the test device in response to user instructions;
receiving the test results from the test device; and
causing the display to display the test results.

25. The telecommunications testing system of claim 24, wherein the controller is coupled to the test device by a wired connection.

26. The telecommunications testing system of claim 24, wherein the controller is coupled to the test device by a wireless connection.

27. The telecommunications testing system of claim 24, wherein the controller includes communication and logic circuitry to determine the type of test device coupled to the controller by interrogating the test device.

28. The telecommunications testing system of claim 24, wherein the suite of tests that can be performed by the test device is a full suite of telecommunications tests.

29. The telecommunications testing system of claim 24, wherein the suite of tests that can be performed by the test device is a subset of a full suite of telecommunications tests.
